(19) United States
(12) Patent Application Publication
(10) Pub. No.: US 2024/0367527 A1
(43) Pub. Date: Nov. 7, 2024

(54) METHOD AND DEVICE FOR OPERATING AN ELECTRICALLY DRIVEN VEHICLE

(71) Applicant: Robert Bosch GmbH, Stuttgart (DE)

(72) Inventor: Falco Sengebusch, Stuttgart (DE)

(21) Appl. No.: 18/688,872

(22) PCT Filed: Jul. 8, 2022
(86) PCT No.: PCT/EP2022/069092

§ 371 Date: Mar. 4, 2024

(30) Foreign Application Priority Data
Sep. 8, 2021 (DE) 10 2021 209 923.8

(51) Int. Cl. B60L 50/60; B60L 53/14; B60L 53/62

(52) U.S. Cl. CPC B60L 50/60; B60L 53/14; B60L 53/62; B60L 2210/10

(57) ABSTRACT

A method (400) for operating an electrically driven vehicle (300), comprising the following steps: emitting a signal for controlling (420) a connectable charging means (160) for charging an intermediate circuit capacitor (140); determining (440) a voltage at an intermediate circuit capacitor (140) or of the charge thereof; emitting a signal for closing (460) the switches (130) for connecting the traction battery (150) to the high-voltage grid (110) as a function of the determined voltage or charge.

### BACKGROUND

The invention relates to a method and a device for operating an electrically driven vehicle. The invention also relates to a drivetrain comprising a corresponding device and a vehicle comprising a drivetrain, as well as a computer program and a computer-readable medium.

Electrically driven vehicles for road traffic are known from the prior art. When an electrically driven vehicle is at rest, the traction battery is electrically isolated from the rest of the high-voltage grid. An electrically driven vehicle is also known as a battery electric vehicle (BEV). A traction battery is also known as a high-voltage (HV) battery. The idle state of a vehicle is an operating state of a parked or parked vehicle whose driver prefers to leave or lock the vehicle. The idle state ends when the driver searches for, opens and starts the vehicle again for a new journey. When the vehicle is started, the traction battery is connected to the high-voltage grid. This is usually done by closing electromechanical switches, relays or contactors on one or both poles (plus and minus) of the traction battery. In an inverter, also connected to the high-voltage grid, there is a comparatively large intermediate circuit capacitor, or capacitor, which is discharged when the vehicle is at rest and is (passively) charged to the battery voltage when the traction battery is connected due to the resulting parallel connection to the traction battery. If the initially resulting very high charging current is not limited in some way, this can lead to damage to the switches, preferably the relay contacts. In today's vehicles, the intermediate circuit capacitor is therefore initially charged via a pre-charging circuit consisting of another, smaller auxiliary relay and a pre-charging resistor at a reduced current. As soon as the intermediate circuit capacitor has reached a predetermined voltage close to the voltage of the traction battery, the traction battery is switched on via the switches. Publication WO2017/125204A1 discloses an alternative to this, namely charging the intermediate circuit capacitor via a bidirectional DC/DC converter. For this purpose, the bidirectional DC/DC converter is arranged between the high-voltage grid and a low-voltage grid or a 12-volt grid of the vehicle electrical system. Energy is drawn from the low-voltage grid, preferably from a 12 V battery. As a result, the intermediate circuit capacitor is charged to the specified voltage (open-circuit voltage of the traction battery). As a rule, the charging process should take place as quickly as possible so that the driver does not experience any delay in being ready to drive when starting the vehicle. In the event of a fault in the boost operation of the DC/DC converter, in which the low voltage, preferably 12 or 48 volts, from the low-voltage grid is to be converted into the high voltage, preferably 400 or 700 volts, of the traction battery in order to charge the intermediate circuit capacitor, the DC/DC converter cannot charge the intermediate circuit capacitor before the traction battery is connected. It is not possible to put into service or start the vehicle in the event of a fault in boost operation. This can only be remedied by replacing or repairing the DC/DC converter. Therefore, a need exists for alternative solutions to a pre-charging circuit that enable the intermediate circuit capacitor to be charged both when the pre-charging circuit is not provided or is defective, and when the boost converter function of the DC/DC converter is defective.

### SUMMARY

A method for operating an electrically driven vehicle is provided. The vehicle comprises a traction battery, a high-voltage grid comprising an intermediate circuit capacitor and high-voltage ports for connecting a charging means for charging the traction battery via the high-voltage grid, and switches for electrically disconnecting and connecting the traction battery to the high-voltage grid. The high-voltage grid is separated from the traction battery by means of switches. The method comprises the following steps: emitting a signal for controlling the connectable charging means for charging the intermediate circuit capacitor; determining the voltage at or the charge in the intermediate circuit capacitor; emitting a signal for closing the switches for connecting the traction battery to the high-voltage grid as a function of the determined voltage or charge.

A method for operating an electrically driven vehicle is provided. To supply an electric machine of an electric drivetrain of the electrically driven vehicle, the vehicle comprises a traction battery which can be electrically connected to a high-voltage grid of the vehicle by means of switches or at least one switch. When the switches are closed, the traction battery is electrically connected to the high-voltage grid; when the switches are open, the traction battery is electrically isolated from the high-voltage grid. The switches are preferably designed as contactors or relays. The high-voltage grid, or DC link, comprises a intermediate circuit capacitor, which is preferably discharged when the switches are open. When the vehicle is at rest, the high-voltage grid is disconnected from the traction battery using the switches. Preferably, an inverter is connected to the high-voltage grid to convert the DC voltage of the traction battery into a multi-phase AC voltage to supply the electric motor of the electrically powered vehicle. The high-voltage grid also comprises high-voltage ports to which an in-vehicle or external charging means can be connected. The charging means can be used to convert the electrical energy from an external energy source into a DC voltage to charge the traction battery. Depending on the charging means, the external energy source can be an alternating current source, preferably the public power grid, or a direct current source, preferably another vehicle.

During the charging process for charging the traction battery via the high-voltage grid, the switches are closed to electrically connect the traction battery to the high-voltage grid. Due to the intermediate circuit capacitor connected to the high-voltage grid, it is not possible to close the switches directly. This would lead to excessive current in the high-voltage grid and destroy the high-voltage grid. The method therefore provides the following steps when the switches are open, i.e., when the high-voltage grid is disconnected from the traction battery by means of the switches: emitting of a signal for controlling the connectable charging means for charging the intermediate circuit capacitor. As long as the traction battery is disconnected from the high-voltage grid via the switches, the charging means is activated to charge the intermediate circuit capacitor in the high-voltage grid. Preferably, this is done by means of a continuously increasing charging voltage so that no high currents are generated in the high-voltage grid during the charging process of the intermediate circuit capacitor. The voltage at or the charge of the intermediate circuit capacitor is also determined. A voltage measuring device, a current measuring device, and/or an integrator element are used to determine the voltage at or the charge of the intermediate circuit capacitor. A signal is emitted to close the switches as a function of the determined voltage or the equivalent charge. The switches are then closed and electrical connection between the high-voltage grid and the traction battery are established without high equalizing currents placing a load on the high-voltage grid. Preferably, the signal to close the switches is emitted when the difference between the determined voltage or the charge equivalent and the voltage of the traction battery falls below a predetermined or presettable threshold value or the determined voltage or the charge equivalent exceeds a presettable voltage value. Preferably, the charging means connected to an external energy source charges the intermediate circuit up to a predetermined voltage. Preferably, the charging means sends a status signal to a higher-level control means to indicate that the intermediate circuit capacitor is sufficiently charged and the switches can be activated. The charging means is preferably configured to regulate the charging voltage from 0 volts to the specified voltage.

In the event of a fault in a pre-charging circuit or a DC/DC converter that is configured for charging or pre-charging the intermediate circuit capacitor, a connectable charging means to the high-voltage ports of the high-voltage grid is controlled and used instead for pre-charging or charging the intermediate circuit capacitor or the DC link. To do this, the charging means must be connected to a power grid or preferably to another vehicle in order to obtain the required energy from there. Once the intermediate circuit capacitor or the DC link has been successfully charged, the traction battery can be switched on. Advantageously, the electrically driven vehicle can then be restarted or put back into operation and preferably driven to the nearest garage or, in an emergency, to a charging point.

In another embodiment of the invention, the vehicle further comprises a low-voltage grid and a bidirectional DC/DC converter for supplying the low-voltage grid from the high-voltage grid, and vice versa. The method first comprises the step of determining an error message from the DC/DC converter before the method steps previously described are performed.

The vehicle also comprises a low-voltage grid and a bidirectional DC/DC converter for supplying the low-voltage grid from the high-voltage grid and vice versa. The low-voltage grid or grid of the vehicle electrical system preferably has a voltage of 12, 24, or 48 volts and is used to supply the control means and electronics of the electrically driven vehicle. The low-voltage grid preferably comprises an on-board power supply battery at the corresponding voltage of the on-board power supply. The bidirectional DC/DC converter is used to supply and charge the low-voltage grid from the high-voltage grid and is operated as a step-down converter for this purpose. For this purpose, the DC/DC converter is connected to the high-voltage grid on the one hand and to the low-voltage grid on the other. Given that the DC/DC converter is bidirectional, it can also transport electrical energy from the low-voltage grid to the high-voltage grid, where it is operated as a step-up converter. The method additionally comprises the step of receiving an error message from the DC/DC converter that the operation of the DC/DC converter is not working. This step is performed before the method steps described hereinabove have been performed. It is therefore advantageous to first check whether the DC/DC converter is defective and only in this case is the charging of the intermediate circuit capacitor triggered by emitting a signal for controlling the connectable charging means.

In another embodiment of the invention, the error message from the DC/DC converter describes an error in the boost operation of the DC/DC converter.

The method comprises the step of receiving an error message from the DC/DC converter. The DC/DC converter error message means or describes that the operation of the DC/DC converter as a boost converter is not working. Advantageously, a more precise error message is determined so that controlling of the connectable charging means is only performed in order to charge the intermediate circuit capacitor if the DC/DC converter is no longer able to transfer the energy from the low-voltage grid to the high-voltage grid.

In another embodiment of the invention, the charging means for charging the intermediate circuit capacitor is connected to an external energy source. In particular, the charging means is connected to a public power grid or to a high-voltage grid of another vehicle.

The charging means converts the electrical energy from an external energy source into a DC voltage for charging the intermediate circuit capacitor. Depending on the charging means, the external energy source can be an alternating current source, preferably the public power grid, or a direct current source, preferably another vehicle. Options for energy sources that can be used to charge the intermediate circuit capacitor using the charging means are shown as an advantage.

In another embodiment of the invention, the step of determining an error message from the DC/DC converter comprises emitting information for establishing a connection to an external energy source.

In the event that a DC/DC converter error message is detected, information or a signal is emitted that a connection to an external energy source is required to charge the intermediate circuit capacitor using the charging means. Advantageously, a user is informed of the need to connect an external energy source to charge the intermediate circuit capacitor using the charging means.

In another embodiment of the invention, the method comprises the following further step: emitting information for parking the vehicle within range of an external energy source for charging the DC link capacitor by means of a connectable charging means to the high-voltage ports.

In the event that the intermediate circuit capacitor can only be charged using the charging means, information is emitted that the vehicle should be parked near or within range of an external energy source. This has the advantage of ensuring that subsequent initial service or restarting can take place.

The invention also relates to a device for operating an electrically driven vehicle. The vehicle comprises a traction battery, a high-voltage grid having an intermediate circuit capacitor, and high-voltage connections for connecting a charging means for charging the traction battery via the high-voltage grid, and switches for electrically disconnecting and connecting the traction battery to the high-voltage grid. The high-voltage grid is separated from the traction battery by means of switches. The device is configured to emit a signal for controlling the connectable charging means for charging the intermediate circuit capacitor, to determine the voltage at or the charge of the intermediate circuit capacitor and to emit a signal for closing the switches for connecting the traction battery to the high-voltage grid as a function of the determined voltage or charge.

A device or control means is provided for operating an electrically driven vehicle. The device is configured to emit a signal for controlling the charging means or a control signal. The device is configured to determine a voltage at the intermediate circuit capacitor or a charge of the intermediate circuit capacitor. The device is also configured to emit a signal to close the switches for connecting the traction battery to the high-voltage grid. Preferably, the device can be designed as a control means. Alternatively, however, it is also possible for the functions of the device to be distributed between two or more control means (e.g., a vehicle control means, the charging means, and an inverter). In this case, the control means are configured to communicate with each other and exchange information, data, and control commands with each other in accordance with the implementation. Advantageously, a device is provided that enables alternative charging of the intermediate circuit capacitor.

The invention also relates to a drivetrain comprising a device as described and, in particular, comprising a traction battery, an inverter, and/or an electric drive. Such a drivetrain is, e.g., used to drive an electric vehicle. Safe operation of the drivetrain is enabled by means of the method and the device.

The invention further relates to a vehicle having a drivetrain as described. Advantageously, a vehicle is thus provided which comprises a device, by means of which alternative charging of the intermediate circuit capacitor is made possible.

The invention also relates to a computer program comprising instructions which cause the device to perform the method steps described.

The invention further relates to a computer-readable medium comprising instructions which, when executed by a computer, prompt the computer to perform the steps of the described method.

It is understood that the features, properties, and advantages of the method according to the invention apply or are correspondingly applicable to the device, or to the drivetrain and vehicle, and vice versa.

Further features and advantages of embodiments of the invention follow from the subsequent description with reference to the accompanying drawings.

### BRIEF DESCRIPTION OF THE DRAWINGS

The invention will be explained in further detail hereinafter with reference to the drawings:

FIG. 1 a schematic representation of a device for operating an electrically driven vehicle,

FIG. 2 a schematically represented vehicle comprising a drivetrain.

FIG. 3 a schematic flow chart for a method of operating an electrically driven vehicle.

### DETAILED DESCRIPTION

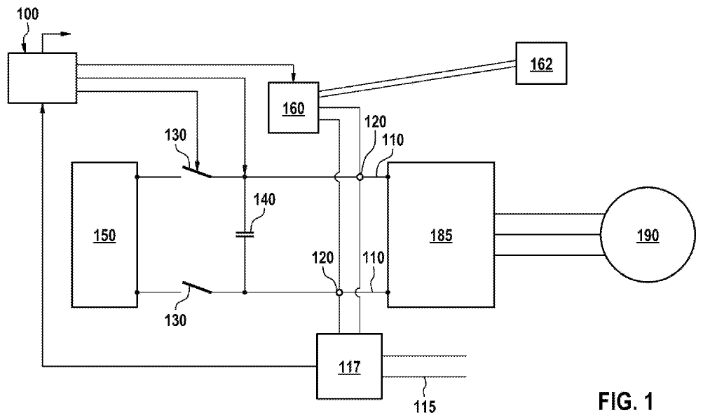

FIG. 1 shows a device 100 for operating an electrically driven vehicle. A traction battery 150 can be connected to a high-voltage grid 110 via switches 130. The high-voltage grid 110 comprises an intermediate circuit capacitor 140 and high-voltage ports 120. The high-voltage ports 120 are configured for connecting a charging means 160 for charging the traction battery 150 via the high-voltage grid 110. One or two switches 130 are provided for electrically disconnecting and connecting the traction battery 150 to the high-voltage grid 110. Preferably, the charging means 160 is connected to an external energy source 162 for charging the intermediate circuit capacitor by means of the connectable charging means 160. The device 100 is configured to emit a signal for controlling the connectable charging means 160 for charging the DC link capacitor 140, to determine the voltage at or the charge of the DC link capacitor 140 and to emit a signal for closing one or the switches 130 for connecting the traction battery 150 to the high-voltage grid 110 as a function of the determined voltage or charge. Preferably, the high-voltage grid is connected to a bidirectional DC/DC converter 117 via the high-voltage ports. Preferably, the low-voltage grid 115 is connected to the bidirectional DC/DC converter 117. Preferably, the high-voltage grid 110 is connected to an inverter 185 for converting the direct voltage into a multi-phase alternating voltage for supplying the electric machine 190 of a drivetrain of an electric vehicle.

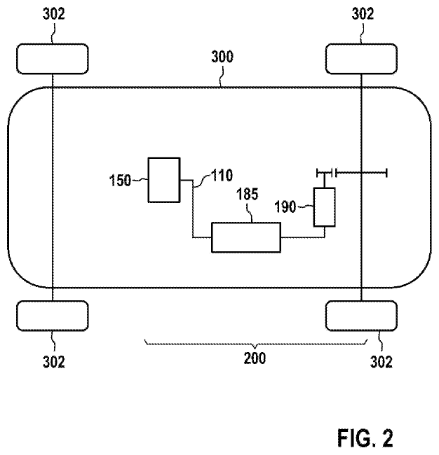

FIG. 2 shows a schematic representation of a vehicle 300 comprising a drivetrain 200. The drawing shows an exemplary vehicle comprising four wheels 302, wherein the invention can be used equally in any vehicle comprising any number of wheels on land, on water and in the air. The drivetrain 200 (shown only in an abstract manner in FIG. 2) comprises a device 100 as described and, in particular, a traction battery 150, a high-voltage grid 110, an inverter 185, and/or an electric machine 190 of an electric drive. Such a drivetrain 200 is, e.g., used to drive an electric vehicle 300. The method and the device enable safe operation of the drivetrain 200.

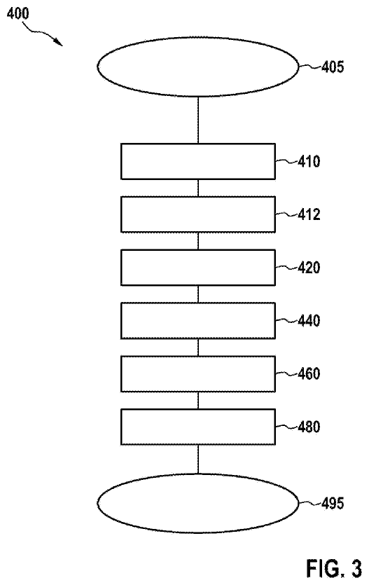

FIG. 3 shows a schematic sequence of a method 400 for operating an electrically driven vehicle 300. The method starts with step 405. Preferably, an error message from the DC/DC converter 117 is determined in step 410. Preferably, information for establishing a connection to an external energy source is emitted in step 412. In step 420, a signal for controlling 420 the connectable charging means 160 to charge the intermediate circuit capacitor 140 is emitted. In step 440, a voltage or charge in the intermediate circuit capacitor 140 is determined. In step 460, a signal for closing the switches 130 for connecting the traction battery 150 to the high-voltage grid 110 is emitted depending on the determined voltage or charge. Preferably, in step 480, information is emitted for parking the vehicle 300 within range of an external power source 162 for charging the intermediate circuit capacitor 140 by means of a charging means 160 connectable to the high voltage ports 120. The method ends at step 495.

1. A method (400) for operating an electrically driven vehicle (300), wherein the vehicle (300) includes
a traction battery (150),
a high-voltage grid (110) having an intermediate circuit capacitor (140) and high-voltage ports (120) for connecting a charging means (160) for charging the traction battery (150) via the high-voltage grid (110), and at least one switch (130) for electrically disconnecting and connecting the traction battery (150) to the high-voltage grid (110),
wherein the high-voltage grid (110) is disconnected from the traction battery (150) by means of at least the one switch or the switches (130), wherein the method comprising the following steps:
emitting a signal for controlling (420) the connectable charging means (160) to charge the intermediate circuit capacitor (140);
determining (440) the voltage across or the charge of the DC link capacitor (140); and
emitting a signal for closing (460) the at least one switch or switches (130) to connect the traction battery (150) to the high-voltage grid (110) as a function of the determined voltage or charge.

2. The method (400) for operating an electrically driven vehicle (300) according to claim 1,
wherein the vehicle (300) further comprises a low-voltage grid (115) and a bidirectional DC-DC converter (117) for supplying the low-voltage grid (115) from the high-voltage grid (110) and vice versa, wherein the method further comprises determining (410) an error message from the DC-DC converter (117) before emitting a signal for controlling (420) the connectable charging means (160) to charge the intermediate circuit.

3. The method (400) for operating an electrically driven vehicle (300) according to claim 2,
wherein the error message from the DC/DC converter (117) describes an error in the boost operation of the DC/DC converter (117).

4. The method (400) for operating an electrically driven vehicle (300) according to claim 1,
wherein the charging means (160) for charging the intermediate circuit capacitor (140) is connected to an external energy source (162).

5. The method (400) for operating an electrically driven vehicle (300) according to claim 2,
wherein the step of determining (410) an error message from the DC-DC converter (117) comprises emitting (412) information about establishing a connection to an external power source (162).

6. The method (400) for operating an electrically driven vehicle (300) according to claim 1,
comprising the following step:
emitting (480) the information about parking the vehicle (300) within range of an external energy source (162) to charge the DC link capacitor (140) by means of a charging means (160), which can be connected to the high-voltage ports (120).

7. A device (100) for operating an electrically driven vehicle (300),
wherein the vehicle (300) comprises a traction battery (150), a high-voltage grid (110) having an intermediate circuit capacitor (140) and high-voltage ports (120) for connecting a charging means (160) for charging the traction battery (150) via the high-voltage grid (110), and at least one switch or switch (130) for electrically disconnecting and connecting the traction battery (150) to the high-voltage grid (110),
wherein the high-voltage grid (110) is disconnected from the traction battery (150) by means of the at least one switch or switches (130),
wherein the device (100) is configured for this purpose,
emitting a signal for controlling (420) the connectable charging means (160) for charging (420) the intermediate circuit capacitor (140); to determine the voltage at or the charge of the intermediate circuit capacitor (140);
emitting a signal for closing (460) the at least one switch or switches (130) for connecting the traction battery (150) to the high-voltage grid (110) as a function of the determined voltage or charge.

8. (canceled)

9. (canceled)

10. (canceled)

11. A non-transitory computer-readable medium comprising instructions which, when executed by a computer, cause the computer to operate an electrically driven vehicle (300), wherein the vehicle (300) includes
a traction battery (150),
a high-voltage grid (110) having an intermediate circuit capacitor (140) and high-voltage ports (120) for connecting a charging means (160) for charging the traction battery (150) via the high-voltage grid (110), and at least one switch (130) for electrically disconnecting and connecting the traction battery (150) to the high-voltage grid (110),
wherein the high-voltage grid (110) is disconnected from the traction battery (150) by means of at least the one switch or the switches (130), by:
emitting a signal for controlling (420) the connectable charging means (160) to charge the intermediate circuit capacitor (140);
determining (440) the voltage across or the charge of the DC link capacitor (140); and
emitting a signal for closing (460) the at least one switch or switches (130) to connect the traction battery (150) to the high-voltage grid (110) as a function of the determined voltage or charge.
